(19) United States
(12) Patent Application Publication
(10) Pub. No.: US 2025/0137148 A1
(43) Pub. Date: May 1, 2025

(54) TITANIUM DIBORIDE WETTABLE CATHODE

(71) Applicant: ZHENGZHOU NON-FERROUS METALS RESEARCH INSTITUTE CO.LTD OF CHALCO, Zhengzhou (CN)

(72) Inventors: Shengzhong BAO, Zhengzhou (CN); Dongsheng LI, Zhengzhou (CN); Kaibin CHEN, Zhengzhou (CN); Huaijiang WANG, Zhengzhou (CN); Guanghui HOU, Zhengzhou (CN); Xu SHI, Zhengzhou (CN); Lifen LUO, Zhengzhou (CN); Fangfang ZHANG, Zhengzhou (CN); Yanhui LIU, Zhengzhou (CN)

(73) Assignee: ZHENGZHOU NON-FERROUS METALS RESEARCH INSTITUTE CO.LTD OF CHALCO, Zhengzhou (CN)

(21) Appl. No.: 19/007,477

(22) Filed: Dec. 31, 2024

Related U.S. Application Data
(63) Continuation of application No. PCT/CN2023/090489, filed on Apr. 25, 2023.

(30) Foreign Application Priority Data
Jan. 31, 2023 (CN) 202310047908.7

(51) Int. Cl. C25B 11/075; B28B 3/00; B28B 11/24; C23C 4/02; C23C 4/10; C23C 4/134; C25B 11/069

(52) U.S. Cl. CPC C25B 11/075; C23C 4/02; C23C 4/10; C23C 4/134; C25B 11/069; B28B 3/003; B28B 11/243

(57) ABSTRACT

A titanium diboride wettable cathode includes a cold-pressed sintered block of titanium diboride, including a titanium diboride and an additive, the additive including a graphite, a carbon fiber and a titanium nitride; and a coating of titanium diboride, coated on a surface of the cold-pressed sintered block of titanium diboride.

### CROSS-REFERENCE TO RELATED APPLICATIONS

This application is a continuation of International Application No. PCT/CN2023/090489, filed on Apr. 25, 2023, which claims a priority to the Chinese patent application No. 202310047908.7 entitled “TITANIUM DIBORIDE WETTABLE CATHODE” and filed on Jan. 31, 2023. The disclosures of the above-referenced applications are hereby incorporated by reference in their entireties.

### TECHNICAL FIELD

The disclosure relates to the field of aluminum electrolysis, and in particular to a titanium diboride wettable cathode.

### BACKGROUND

Wettable cathodes are very important for the development of both an aluminum electrolysis with an inert anode and an aluminum electrolysis with a prebaked carbon anode. When an inert anode is used, a reaction equation of the aluminum electrolysis is transformed from Al₂O₃+C═Al+CO₂ to Al₂O₃═Al+O₂, and a theoretical decomposition voltage also increases from 1.2 V to 2.2 V. That is, the theoretical decomposition voltage of the aluminum electrolysis when the inert anode is used is 1 V higher than the theoretical decomposition voltage when a carbon anode is used. The aluminum electrolysis with the inert anode, if it is required to have the same or less energy consumption than the aluminum electrolysis with the prebaked carbon anode, must cooperate with a wettable cathode and use an aluminum electrolyzer with a vertical electrode structure. Currently, the aluminum electrolysis with the prebaked carbon anode has achieved a significant reduction in energy consumption by reducing a voltage drop of peripheral conductors (such as anodes, steel claws, cathodes, cathode steel rods, and peripheral busbars and so on) and the horizontal current. Using a wettable cathode to achieve a “dry cathode” operation, that is, eliminating an liquid aluminum layer is an important choice for deep energy saving in the next stage. Without a fluctuation and a heat dissipation loss of the liquid aluminum layer, a pole distance may be less than 3.5 cm or even lower, thereby significantly reducing the voltage of the electrolyzer and energy consumption.

Whether it is the aluminum electrolysis with the inert anode or the aluminum electrolysis with the prebaked carbon anode, requirements for the wettable cathodes are higher without the liquid aluminum layer or with a thin liquid aluminum layer. First, a good wettability is required, and therefore liquid aluminum can precipitate directly on the surface of the wettable cathode. Secondly, without the protection of the liquid aluminum layer, the performance of a cathode itself in resisting penetration and corrosion of an electrolyte melt and sodium and potassium needs to be greatly strengthened.

At present, a titanium diboride (TiB₂) is an ideal material for the wettable cathode. Pure titanium diboride has the advantages of good electrical conductivity, high strength, wear resistance, and good wettability with the liquid aluminum, and also has strong resistance to the corrosion of electrolyte melt and liquid aluminum, and the penetration of sodium and potassium. Typically, existing wettable cathodes made of titanium diboride materials may be classified into three categories: titanium diboride ceramic cathodes, titanium diboride composite material cathodes, and titanium diboride coating cathodes. These three categories of wettable cathodes all have certain problems. The titanium diboride ceramic cathodes have a difficult preparation, high cost, poor thermal shock resistance, and severely restricted industrial application. The titanium diboride composite material cathodes have a high carbon content, high porosity, and short service life; and the titanium diboride coating cathodes have an easy peeling and short life. Thus this makes the titanium diboride still difficult to be applied to the wettable cathodes.

### SUMMARY

The disclosure intends to provide a titanium diboride wettable cathode to solve a technical problem in the prior art that a titanium diboride is difficult to be applied to wettable cathodes.

According to the first aspect of the disclosure, provided is a titanium diboride wettable cathode, comprising: a titanium diboride: a cold-pressed sintered block, which comprises titanium diboride and an additive, wherein the additive comprises a graphite, a carbon fiber and a titanium nitride; and a coating of titanium diboride, coated on a surface of the cold-pressed sintered block of titanium diboride.

According to a second aspect of the disclosure, provided is a method for preparing a titanium diboride wettable cathode, including the following steps: mixing a titanium diboride powder, an additive, a water, a dispersant, and a binder to form a slurry, wherein the additive comprises a graphite, a carbon fiber, and a titanium nitride; granulating the slurry by spray-drying to obtain a powder; performing an isostatic pressing treatment on the powder to obtain a briquette; processing and adjusting a shape and size of the briquette, followed by performing a high-temperature degreasing treatment on the briquette at a first temperature and under an inert atmosphere to obtain a degreased briquette; sintering the degreased briquette for densification at a second temperature and under the inert atmosphere to obtain a cold-pressed sintered block of titanium diboride; and plasma-spraying a titanium diboride micropowder, as raw material, onto a surface of the cold-pressed sintered block of titanium diboride to form a coating of titanium diboride, thereby obtaining the titanium diboride wettable cathode.

### BRIEF DESCRIPTION OF DRAWINGS

To illustrate technical solutions more clearly in embodiments of the disclosure, a brief introduction will be given below to accompanying drawings needed to be used in the description of the embodiments. Obviously, the accompanying drawings described in the following show some embodiments of the disclosure. For those of ordinary skill in the art, other accompanying drawings can also be obtained based on these accompanying drawings without creative efforts.

FIG. 1 shows a schematic flow diagram of a method for preparing a titanium diboride wettable cathode according to some embodiments of the disclosure.

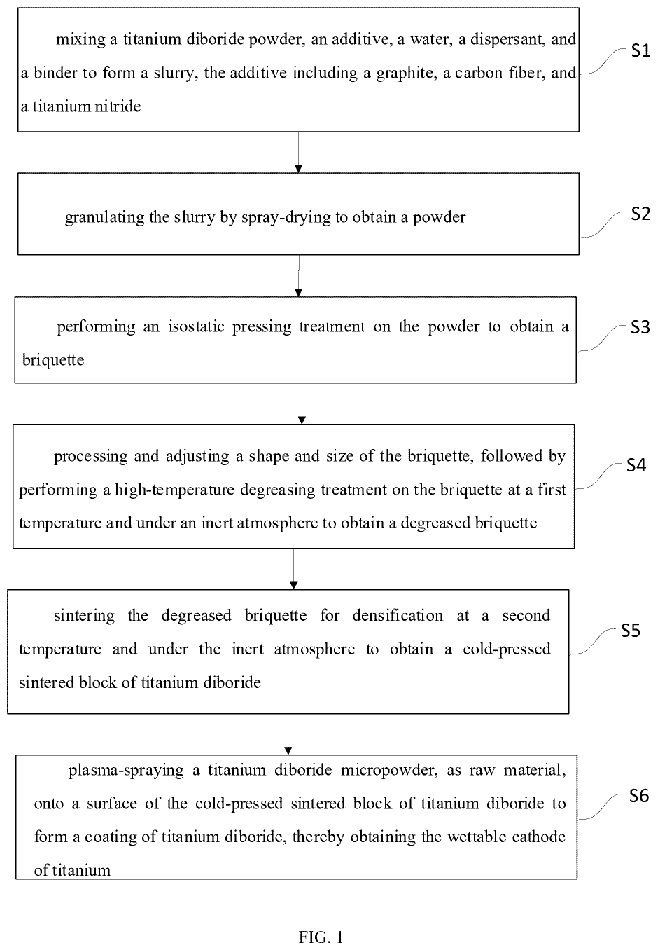

### DESCRIPTION OF EMBODIMENTS

The disclosure will be described in detail below with reference to specific embodiments and examples, from which advantages and various effects of the disclosure will be more clearly presented. Those skilled in the art should understand that these specific embodiments and examples are used to illustrate the disclosure, but not to limit the disclosure.

Throughout this specification, unless otherwise specifically stated, the terms used herein are to be understood as having the meaning commonly used in the art. Therefore, unless otherwise defined, all technical and scientific terms used herein have the same meaning as commonly understood by one of ordinary skill in the art to which this disclosure belongs. If there is any conflict, this specification takes precedence. Unless otherwise specified, various raw materials, reagents, instruments, and apparatuses used in the disclosure are commercially available or obtained through existing methods.

Various embodiments of the disclosure may exist in the form of a range; it should be understood that the description in the form of a range is only for convenience and simplicity and should not be understood as a hard limit to the scope of the disclosure; therefore, the described range should be considered to have specifically disclosed all possible subranges as well as the single values within such a range. For example, a description of a range from 1 to 6 should be considered to have specifically disclosed subranges, such as from 1 to 3, from 1 to 4, from 1 to 5, from 2 to 4, from 2 to 6, and from 3 to 6, and a single number within the stated range, such as 1, 2, 3, 4, 5, and 6, which applies regardless of the range. Additionally, whenever a numerical range is indicated herein, it is intended to include any cited number (fractional or whole) within the indicated range.

In the disclosure, unless otherwise specified, the directional words used such as “upper” and “lower” refer specifically to the direction of the figure in the drawing. In addition, in the description of the disclosure, the terms “including”, “comprising” and the like refer to “including but not limited to”. Furthermore, the terms “include”, “comprise” or any other variations thereof are intended to cover a non-exclusive inclusion such that a process, method, article, or apparatus that includes a list of elements includes not only those elements, but also those not expressly listed other elements, or elements inherent to the process, method, article or apparatus. In the disclosure, relational terms such as “first” and “second” are merely used to distinguish one entity or operation from another and do not necessarily require or imply any such actual relationship or sequence between these entities or operations. In the disclosure, “and/or” describes the relationship between associated objects, indicating that there may be three relationships. For example, A and/or B may refer to A alone, both A and B, and B alone. For the association relationship of more than three associated objects described with “and/or”, it represents that any one of the three associated objects can exist alone, or at least two of them can exist at the same time. For example, “A, and/or B, and/or C” can represent that any one of A, B, and C exist alone, or any two of them exist at the same time, or three of them exist at the same time. In the disclosure, “at least one” refers to one or more, and “plurality” refers to two or more. “At least one”, “at least one of the following” or similar expressions thereof refer to any combination of these items, including single items or any combination of plural items. For example, “at least one of a, b, or c”, or “at least one of a, b, and c” may represent a, b, c, a˜b (that is, a and b), a˜c, b˜c, or a˜b-c, where a, b, and c can each be single or multiple.

In a first aspect, an embodiment of the disclosure provides a titanium diboride wettable cathode that includes: a cold-pressed sintered block of titanium diboride which includes a titanium diboride and an additive, the additive including a graphite, a carbon fiber and a titanium nitride; and a coating of titanium diboride, that is coated on a surface of the cold-pressed sintered block of titanium diboride.

The carbon fiber can play a role in increasing a strength of the cold-pressed sintered block of titanium diboride. The titanium nitride can assist in sintering. Those skilled in the art can understand that carbon-containing composite ceramic materials based on titanium diboride are generally processed by a hot pressing and sintering process. A hot pressing and sintering process is a key factor leading to a high cost of a hot-pressed titanium diboride-C composite ceramic, and accounts for approximately 75% of a total cost. Therefore, in the disclosure, a cost can be significantly reduced by adopting a cold pressing and sintering process instead of the hot pressing and sintering process. Density and strength of the cold-pressed sintered block obtained by cold pressing and sintering press, compared with that of the hot pressing and sintering process, will be relatively weaker. In the disclosure, measures such as a carbon fiber reinforcement, a titanium nitride assisted sintering and an isostatic pressing molding are adopted, and therefore the strength and density of the cold-pressed sintered blocks can be greatly improved and a required sintering temperature is also reduced. A cost of process in the disclosure is much lower than that of the hot-pressing process. A coating of titanium diboride may be formed by a plasma-spraying, a cost of which is related to a surface area. It is estimated to be less than 1,500 RMB/m². An increase in cost from measures for improving the strength and density of the cold-pressed sintered block of titanium diboride is smaller. Comprehensive calculations show that the cost of the disclosure may be reduced by 30% or even more than 50% compared to that of a carbon-containing titanium diboride hot-pressed ceramic cathode. In the disclosure, a cold-pressed sintered block of titanium diboride with low carbon content is used as a matrix, and a coating of titanium diboride is further provided on a surface of the matrix to obtain a titanium diboride wettable cathode, thereby further reducing a porosity of surface of the wettable cathode and improving an overall performance of the wettable cathode. Pure titanium diboride has advantages of good electrical conductivity, high strength, wear resistance, and good wettability with the liquid aluminum, and also has strong resistance to the corrosion of electrolyte melt and liquid aluminum, and to the penetration of sodium-potassium. The disclosure fully combines the advantages of the cold-pressed sintered block of titanium diboride and the pure titanium diboride, and therefore a performance of a surface of the obtained titanium diboride wettable cathode can reach a level similar to that of a surface of a pure titanium diboride ceramic wettable cathode.

In conclusion, the disclosure discloses a titanium diboride wettable cathode with low carbon content, which has the following advantages: (1) a preparation cost is significantly reduced, in comparison with the carbon-containing titanium diboride hot-pressed ceramic cathode or the pure titanium diboride ceramic cathode; (2) in comparison with the carbon-containing titanium diboride hot-pressed ceramic cathode or pure titanium diboride ceramic cathode, a sample of a cold-pressed sintered block of titanium diboride will not be limited in structural size, has a strong thermal shock resistance, and is easy to be machined; (3) in comparison with a conventional titanium diboride-C composite cathode and an ordinary titanium diboride coated cathode, the titanium diboride wettable cathode in the disclosure has a very low carbon content, a high density, a good wettability with the liquid aluminum, and a better performance of resisting the penetration and corrosion of the electrolyte melt and the sodium-potassium, and therefore intercalation structures are less likely to be generated, and the service life is longer; and (4) needs of an aluminum electrolysis with inert anode technology and an aluminum electrolysis with prebaked carbon anode technology for wettable cathodes under conditions of thin liquid aluminum layer or no liquid aluminum layer can also be met at the same time. In the disclosure, by adopting measures such as the carbon fiber reinforcement, the titanium nitride assisted sintering, the isostatic pressing molding and the like, the strength and density of the cold-pressed sintered block of titanium diboride are greatly improved, and the required sintering temperature is reduced, so that in the disclosure the cold pressing and sintering process with lower cost can be adopted, and the cold-pressed sintered block of titanium diboride is not limited in the structural size, and has a strong thermal shock resistance, and is easy to be processed. Meanwhile, the surface of the cold-pressed sintered block of titanium diboride is provided with a coating of titanium diboride thereon, and therefore the performance of the surface of the obtained titanium diboride wettable cathode can reach a level similar to that of pure titanium diboride ceramic wettable cathode.

In some embodiments of the disclosure, a cold-pressed sintered block of titanium diboride comprises 16 to 19 parts by weight of a titanium diboride and 1 to 4 parts by weight of the additive.

In some embodiments of the disclosure, in terms of a mass fraction accounted for in the additive, the additive comprises: 0.1%-2% carbon fiber; 0.5%-10% titanium nitride; and 0.5%-5% titanium oxide; and the remainder is graphite.

A proportion of the above additive can make the titanium diboride wettable cathode has low carbon content and high density.

In some embodiments of the disclosure, a thickness of the coating of titanium diboride may be 200-1000 μm.

In a second aspect, according to an embodiment of the disclosure, a method for preparing a titanium diboride wettable cathode is provided, comprising:
step S1: mixing a titanium diboride powder, an additive, a water, a dispersant, and a binder to form a slurry, the additive comprising a graphite, a carbon fiber, and a titanium nitride;
step S2: granulating the slurry by spray-drying to obtain a powder;
step S3: performing an isostatic pressing treatment on the powder to obtain a briquette;
step S4: processing and adjusting a shape and size of the briquette, followed by performing a high-temperature degreasing treatment on the briquette at a first temperature and under an inert atmosphere to obtain a degreased briquette;
step S5: sintering the degreased briquette for densification at a second temperature and under the inert atmosphere to obtain a cold-pressed sintered block of titanium diboride; and
step S6: plasma-spraying a titanium diboride micropowder, as raw material, onto a surface of the cold-pressed sintered block of titanium diboride to form a coating of titanium diboride, thereby obtaining the titanium diboride wettable cathode.

Those skilled in the art can understand that the method for preparing the titanium diboride wettable cathode may be used for preparing the titanium diboride wettable cathode described in the first aspect. Therefore, technical solutions according to the second aspect of the disclosure have the advantageous effects of any embodiment of the first aspect, which will not be described again here. The inert gas described in the disclosure refers to at least one of nitrogen gas or rare gas. The plasma-spraying is beneficial to a formation of a dense coating. Those skilled in the art can understand that before the plasma-spraying, the surface of the cold-pressed sintered block of titanium diboride is generally roughened, cleaned, and dried as a whole.

In some embodiments of the disclosure, a mass ratio of the titanium diboride powder to the additive may be 16˜19:1˜4.

In some embodiments of the disclosure, in terms of a mass fraction accounted for in the additive, the additive may comprise: 0.1%-2% carbon fiber; 0.5%-10% titanium nitride; and 0.5%-5% titanium oxide; and the remainder is graphite.

In some embodiments of the disclosure, the first temperature may be 400˜600° C.; and/or the second temperature may be 1250-1400° C.; and/or a duration of the high-temperature degreasing treatment may be 4˜6 h; and/or a pressure of the isostatic pressing treatment may be 120˜200 MPa; and/or the dispersant may be at least one of alcohol, polyacrylamide, and fatty acid polyethylene glycol ester; and/or the binder may be polyvinyl alcohol.

In some embodiments of the disclosure, a particle size d50 of the titanium diboride micropowder may be 15-25 μm; and/or the plasma-spraying may be atmospheric pressure plasma-spraying or vacuum plasma-spraying; and/or the plasma-spraying may be completed in 5-20 times with a thickness of 10-50 μm per spray; and/or a thickness of the coating of titanium diboride may be 200-1000 μm; and/or before the plasma-spraying, the cold-pressed sintered block of titanium diboride may be preheated to 100-200° C.

In some embodiments of the disclosure, the plasma-spraying is atmospheric pressure plasma-spraying, 5N high-purity argon gas may be used as a gas for carrying powder, and 5N high-purity hydrogen gas or 5N high-purity helium gas may be used as an auxiliary gas during the plasma-spraying.

An oxidation of the titanium diboride powder during a high-temperature spraying process can be reduced by using 5N high-purity argon gas as a carrier gas for carrying powder and 5N high-purity hydrogen gas or 5N high-purity helium gas as an auxiliary gas.

The disclosure will be further described below with reference to specific examples. It should be understood that these examples are only used to illustrate the disclosure and are not intended to limit the scope of the disclosure. Experimental methods without specifying specific conditions in the following examples are typically performed in accordance with national standards in China. If there are no corresponding national standards in China, general international standards, conventional conditions, or conditions recommended by the manufacturer shall be followed.

### EXAMPLE 1

95 wt % titanium diboride powder, 1 wt % carbon fiber, 1 wt % titanium nitride powder, 0.5 wt % titanium oxide powder, and 2.5 wt % graphite powder were mixed uniformly in a three-dimensional mixer to obtain a powder material; a pure water with a mass ratio of 1:1 to the powder material was added, polyacrylamide and polyvinyl alcohol solutions were added, and the mixture was ball milled and mixed to form a slurry; the slurry was granulated by the spray-drying and then molded to form a briquette in an isostatic press at 200 MPa, and the briquette was processed to obtain a required cathode structure morphology; the processed briquette was degreased at 600°° C. under a nitrogen atmosphere for 4 h to obtain a degreased briquette; and the degreased briquette was sintered for densification at 1400° C. under an argon atmosphere, thereby obtaining a cold-pressed sintered block of titanium diboride. Upon testing and analysis, a porosity of the cold-pressed sintered block of titanium diboride was 12.5%, and a bending strength under an ambient temperature of the cold-pressed sintered block of titanium diboride was 48 MPa.

The prepared cold-pressed sintered block of titanium diboride was surface roughened, cleaned, and dried as a whole; a titanium diboride powder, with a purity greater than 98% and a particle size d50 of 25 μm, was provided as a raw material for an atmospheric pressure plasma-spraying using 5N high-purity argon gas as a gas for carrying powder and 5N high-purity hydrogen gas as an auxiliary gas; a thickness of each spraying is 10˜50 μm, and the coating of titanium diboride was formed after 20 times of spraying; and before the first spraying, a spray gun was used to preheat a material of the matrix under a temperature about 160° C. Upon testing and analysis, in the coating of titanium diboride, an oxygen content was 9.6%, the porosity was 8.4%, and a bonding strength between the coating and the matrix was 6.7 N·mm⁻².

The wettable cathode prepared according to the above process had a width×height×thickness=10 cm×25 cm×3.5 cm, was installed vertically at a bottom of an aluminum electrolyzer with an inert anode, had an actual working area of 200 cm²×2, and was matched with two inert anodes. After the wettable cathode ran for 1000 h under a condition of 820° C., 200 A current and a cathode current density of 0.5 A/cm² in a KF—NaF—AlF₃-Al₂O₃ electrolyte system, the wettable cathode was intact and well wetted with liquid aluminum.

### EXAMPLE 2

80 wt % titanium diboride powder, 2 wt % carbon fiber, 10 wt % titanium nitride powder, 0.5 wt % titanium oxide powder, and 7.5 wt % graphite powder were mixed uniformly in a three-dimensional mixer to obtain a powder material; a pure water with a mass ratio of 1:1 to the powder material was added, fatty acid polyethylene glycol ester and polyvinyl alcohol solutions were added, and the mixture was ball milled and mixed to form a slurry; the slurry was granulated by the spray-drying and then molded to form a briquette in an isostatic press at 180 MPa, and the briquette was processed to obtain a required cathode structure morphology; the processed briquette was degreased at 400°° C. under a nitrogen atmosphere for 6 h to obtain a degreased briquette; and the degreased briquette was sintered for densification at 1350° C. under an argon atmosphere, thereby obtaining a cold-pressed sintered block of titanium diboride. Upon testing and analysis, the porosity of the cold-pressed sintered block of titanium diboride was 11.2%, and the bending strength under an ambient temperature of the cold-pressed sintered block of titanium diboride was 52 MPa.

The prepared cold-pressed sintered block of titanium diboride was surface roughened, cleaned, and dried as a whole; a titanium diboride powder, with a purity greater than 98% and a particle size d50 of 25 μm, was provided as a raw material for an atmospheric pressure plasma-spraying using 5N high-purity argon gas as a gas for carrying powder and 5N high-purity hydrogen gas as an auxiliary gas; a thickness of each spraying is 10-50 μm, and the coating of titanium diboride was formed after 20 times of spraying; and before the first spraying, a spray gun was used to preheat a material of the matrix to a temperature of about 120°° C. Upon testing and analysis, in the coating of titanium diboride, an oxygen content was 10.3%, the porosity was 8.8%, and a bonding strength between the coating and the matrix was 6.4 N·mm⁻².

The wettable cathode prepared according to the above process: had a width×height×thickness=10 cm×25 cm×3.5 cm, was installed vertically at a bottom of an aluminum electrolyzer with an inert anode, had an actual working area of 200 cm²×2, and was matched with two inert anodes. After the wettable cathode ran for 1000 h under a condition of 820° C., 200A current and a cathode current density of 0.5 A/cm² in a KF—NaF—AlF₃-Al₂O₃ electrolyte system, the wettable cathode was intact and well wetted with liquid aluminum.

### EXAMPLE 3

80 wt % titanium diboride powder, 0.1 wt % carbon fiber, 0.5 wt % titanium nitride powder, 5 wt % titanium oxide powder, and 14.4 wt % graphite powder were mixed uniformly in a three-dimensional mixer to obtain a powder material; a pure water with a mass ratio of 1:1 to the powder material was added, fatty acid polyethylene glycol ester and polyvinyl alcohol solutions were added, and the mixture was ball milled and mixed to form a slurry; the slurry was granulated by the spray-drying and then molded to form a briquette in an isostatic press at 160 MPa, and the briquette was processed to obtain a required cathode structure morphology; the processed briquette was degreased at 500° C. under a nitrogen atmosphere for 4 h to obtain a degreased briquette; and the degreased briquette was sintered for densification at 1350° C. under an argon atmosphere, thereby obtaining a cold-pressed sintered block of titanium diboride. Upon testing and analysis, the porosity of the cold-pressed sintered block of titanium diboride was 11.8%, and the bending strength under an ambient temperature of the cold-pressed sintered block of titanium diboride was 44 MPa.

The prepared cold-pressed sintered block of titanium diboride was surface roughened, cleaned, and dried as a whole; a titanium diboride powder, with a purity greater than 98% and a particle size d50 of 25 μm, was provided as a raw material for an atmospheric pressure plasma-spraying using 5N high-purity argon gas as a gas for carrying powder and 5N high-purity hydrogen gas as an auxiliary gas; a thickness of each spraying is 10˜50 μm, and the coating of titanium diboride was formed after 20 times of spraying; and before the first spraying, a spray gun was used to preheat a material of the matrix to a temperature of about 200°° C. Upon testing and analysis, in the coating of titanium diboride, an oxygen content was 11.2%, the porosity was 9.2%, and a bonding strength between the coating and the matrix was 5.8 N·mm⁻².

A wettable cathode block with a slope side prepared according to the above process: had a rectangular orthographic projection of length×width=20 cm×15 cm, was installed at a bottom of a laboratory scale aluminum electrolyzer with a carbon anode, was tilted with a height of 12 cm at one end and a height of 10 cm at the other end, and was matched with a carbon anode with the same tilt angle to form a diversion channel structure and had an actual working area of 300 cm²×2. After the wettable cathode block with a slope side ran for 48 h under a condition of 820° C., 240 A current and a cathode current density of 0.8 A/cm² in a KF—NaF—AlF₃—Al₂O₃ electrolyte system, the wettable cathode block with a slope side was intact and well wetted with liquid aluminum.

### EXAMPLE 4

80 wt % titanium diboride powder, 1 wt % carbon fiber, 5 wt % titanium nitride powder, 2wt % titanium oxide powder, and 12 wt % graphite powder were mixed uniformly in a three-dimensional mixer to obtain a powder material; a pure water with a mass ratio of 1:1 to the powder material was added, fatty acid polyethylene glycol ester and polyvinyl alcohol solutions were added, and the mixture was ball milled and mixed to form a slurry; the slurry was granulated by the spray-drying and then molded to form a briquette in an isostatic press at 180 MPa, and the briquette was processed to obtain a required cathode structure morphology; the processed briquette was degreased at 600° C. under a nitrogen atmosphere for 4 h to obtain a degreased briquette; and the degreased briquette was sintered for densification at 1400° C. under an argon atmosphere, thereby obtaining a cold-pressed sintered block of titanium diboride. Upon testing and analysis, the porosity of the cold-pressed sintered block of titanium diboride was 10.2%, and the bending strength under an ambient temperature of the cold-pressed sintered block of titanium diboride was 63 MPa.

The prepared cold-pressed sintered block of titanium diboride was surface roughened, cleaned, and dried as a whole; a titanium diboride powder, with a purity greater than 98% and a particle size d50 of 25 μm, was provided as a raw material for an atmospheric pressure plasma-spraying using 5N high-purity argon gas as a gas for carrying powder and 5N high-purity hydrogen gas as an auxiliary gas; a thickness of each spraying is 10˜50 μm, and the coating of titanium diboride was formed after 20 times of spraying; and before the first spraying, a spray gun was used to preheat a material of the matrix to a temperature of about 180° C. Upon testing and analysis, in the coating of titanium diboride, an oxygen content was 9.2%, the porosity was 8.4%, and a bonding strength between the coating and the matrix was 7.5 N·mm⁻².

The wettable cathode prepared according to the above process: had a width×height×thickness=10 cm×25 cm×3.5 cm, was installed vertically at a bottom of an aluminum electrolyzer with an inert anode, had an actual working area of 200 cm²×2, was matched with two inert anodes. After the wettable cathode ran for 1000 h under a condition of 820° C. and 200 A current and a cathode current density of 0.5 A/cm² in a KF—NaF—AlF₃—Al₂O₃ electrolyte system, the wettable cathode was intact and well wetted with liquid aluminum.

### EXAMPLE 5

85 wt % titanium diboride powder, 1 wt % carbon fiber, 5 wt % titanium nitride powder, 0.5 wt % titanium oxide powder, and 8.5 wt % graphite powder were mixed uniformly in a three-dimensional mixer to obtain a powder material; a pure water with a mass ratio of 1:1 to the powder material was added, fatty acid polyethylene glycol ester and polyvinyl alcohol solutions were added, and the mixture was ball milled and mixed to form a slurry; the slurry was granulated by the spray-drying and then molded to form a briquette in an isostatic press at 180 MPa, and the briquette was processed to obtain a required cathode structure morphology; the processed briquette was degreased at 600° C. under a nitrogen atmosphere for 4 h to obtain a degreased briquette; and the degreased briquette was sintered for densification at 1350° C. under an argon atmosphere, thereby obtaining a cold-pressed sintered block of titanium diboride. Upon testing and analysis, the porosity of the cold-pressed sintered block of titanium diboride was 10.8%, and the bending strength under an ambient temperature of the cold-pressed sintered block of titanium diboride was 58 MPa.

The prepared cold-pressed sintered block of titanium diboride was surface roughened, cleaned, and dried as a whole; a titanium diboride powder, with a purity greater than 98% and a particle size d50 of 25 μm, was provided as a raw material for an atmospheric pressure plasma-spraying using 5N high-purity argon gas as a gas for carrying powder and 5N high-purity hydrogen gas as an auxiliary gas; a thickness of each spraying is 10-50 μm, and the coating of titanium diboride was formed after 20 times of spraying; and before the first spraying, a spray gun was used to preheat a material of the matrix to a temperature of about 200°° C. Upon testing and analysis, in the coating of titanium diboride, an oxygen content was 10.5%, the porosity was 8.6%, and a bonding strength between the coating and the matrix was 7.8 N·mm⁻².

A wettable cathode block with a slope side prepared according to the above process had a rectangular orthographic projection of length×width=20 cm×15 cm, and was installed at a bottom of a laboratory scale aluminum electrolyzer with a carbon anode. The wettable cathode block was tilted with a height of 12 cm at one end and a height of 10 cm at the other end, and was matched with a carbon anode with the same tilt angle to form a diversion channel structure and had an actual working area of 300 cm². After the wettable cathode block with a slope side ran for 48 h under a condition of 820° C. and 240 A current and a cathode current density of 0.8A/cm² in a KF—NaF—AlF₃—Al₂O₃ electrolyte system, the wettable cathode block with a slope side was intact and well wetted with liquid aluminum.

Some embodiments of the disclosure have the following advantages compared with the prior art: the titanium diboride wettable cathode provided by the embodiments of the disclosure, measures such as the carbon fiber reinforcement, the titanium nitride assisted sintering, the isostatic pressing molding and the like are adopted, and therefore the strength and density of the cold-pressed sintered block of titanium diboride are greatly improved, and the required sintering temperature is reduced, so that in the disclosure the cold pressing and sintering process with lower cost can be adopted, the cold-pressed sintered block of titanium diboride is not limited in the structural size, has a strong thermal shock resistance, and is easy to be processed. Meanwhile, the surface of the cold-pressed sintered block of titanium diboride is provided with a coating of titanium diboride thereon, and therefore the performance of the surface of the obtained titanium diboride wettable cathode can reach a level similar to that of the pure titanium diboride ceramic wettable cathode.

The above descriptions are only specific embodiments of the disclosure, enabling those skilled in the art to understand or implement the disclosure. Various modifications to these embodiments will be readily apparent to those skilled in the art, and the generic principle defined herein may be practiced in other embodiments without departing from the spirit or scope of the disclosure. Therefore, the disclosure is not to be limited to the embodiments shown herein but is to be accorded the widest scope consistent with the principles and novel features claimed herein.

What is claimed is:

1. A titanium diboride wettable cathode, comprising:
a cold-pressed sintered block of titanium diboride, comprising a titanium diboride and an additive, the additive comprising a graphite, a carbon fiber and a titanium nitride; and
a coating of titanium diboride, coated on a surface of the cold-pressed sintered block of titanium diboride.

2. The titanium diboride wettable cathode according to claim 1, wherein the cold-pressed sintered block of titanium diboride comprises 16 to 19 parts by weight of titanium diboride and 1 to 4 parts by weight of the additive.

3. The titanium diboride wettable cathode according to claim 2, wherein in terms of a mass fraction accounted for in the additive, the additive comprises:
0.1%˜2% carbon fiber; 0.5%˜10% titanium nitride; and 0.5%˜5% titanium oxide; and the remainder is the graphite.

4. The titanium diboride wettable cathode according to claim 1, wherein the coating of titanium diboride has a thickness of 200-1000 μm.

5. A method for preparing a titanium diboride wettable cathode, comprising:
mixing a titanium diboride powder, an additive, a water, a dispersant, and a binder to form a slurry, wherein the additive comprises a graphite, a carbon fiber, and a titanium nitride;
granulating the slurry by spray-drying to obtain a powder;
performing an isostatic pressing treatment on the powder to obtain a briquette;
processing and adjusting a shape and size of the briquette, followed by performing a high-temperature degreasing treatment on the briquette at a first temperature and under an inert atmosphere to obtain a degreased briquette;
sintering the degreased briquette for densification at a second temperature and under the inert atmosphere to obtain a cold-pressed sintered block of titanium diboride; and
plasma-spraying a titanium diboride micropowder, as raw material, onto a surface of the cold-pressed sintered block of titanium diboride to form a coating of titanium diboride, thereby obtaining the titanium diboride wettable cathode.

6. The method for preparing the titanium diboride wettable cathode according to claim 5, wherein a mass ratio of the titanium diboride powder to the additive is 16˜19:1˜4.

7. The method for preparing the titanium diboride wettable cathode according to claim 6, wherein in terms of a mass fraction accounted for in the additive, the additive comprises:
0.1%˜2% carbon fiber; 0.5%˜10% titanium nitride; and 0.5%˜5% titanium oxide; and the remainder is the graphite.

8. The method for preparing the titanium diboride wettable cathode according to claim 5, wherein the first temperature is 400˜600° C.; and/or
the second temperature is 1250˜1400° C.; and/or
a duration of the high-temperature degreasing treatment is 4˜6 h; and/or
a pressure of the isostatic pressing treatment is 120˜200 MPa; and/or
the dispersant is at least one of alcohol, polyacrylamide, and fatty acid polyethylene glycol ester; and/or
the binder is polyvinyl alcohol.

9. The method for preparing the titanium diboride wettable cathode according to claim 5, wherein a particle size d50 of the titanium diboride micropowder is 15˜25 μm; and/or
the plasma-spraying is atmospheric pressure plasma-spraying or vacuum plasma-spraying; and/or
the plasma-spraying is completed in 5˜20 times with a thickness of 10˜50 μm per spray; and/or
a thickness of the coating of titanium diboride is 200˜1000 μm; and/or
before the plasma-spraying, the cold-pressed sintered block of titanium diboride is preheated to 100˜200° C.

10. The method for preparing the titanium diboride wettable cathode according to claim 5, wherein the plasma-spraying is atmospheric pressure plasma-spraying, and 5N high-purity argon gas is used as a gas for carrying powder and 5N high-purity hydrogen gas or 5N high-purity helium gas is used as an auxiliary gas during the plasma-spraying.

11. The method for preparing the titanium diboride wettable cathode according to claim 6, wherein the plasma-spraying is atmospheric pressure plasma-spraying, and 5N high-purity argon gas is used as a gas for carrying powder and 5N high-purity hydrogen gas or 5N high-purity helium gas is used as an auxiliary gas during the plasma-spraying.

12. The method for preparing the titanium diboride wettable cathode according to claim 7, wherein the plasma-spraying is atmospheric pressure plasma-spraying, and 5N high-purity argon gas is used as a gas for carrying powder and 5N high-purity hydrogen gas or 5N high-purity helium gas is used as an auxiliary gas during the plasma-spraying.

13. The method for preparing the titanium diboride wettable cathode according to claim 8, wherein the plasma-spraying is atmospheric pressure plasma-spraying, and 5N high-purity argon gas is used as a gas for carrying powder and 5N high-purity hydrogen gas or 5N high-purity helium gas is used as an auxiliary gas during the plasma-spraying.

14. The method for preparing the titanium diboride wettable cathode according to claim 9, wherein the plasma-spraying is atmospheric pressure plasma-spraying, and 5N high-purity argon gas is used as a gas for carrying powder and 5N high-purity hydrogen gas or 5N high-purity helium gas is used as an auxiliary gas during the plasma-spraying.
